(19) United States
(12) Patent Application Publication
(10) Pub. No.: US 2011/0115178 A1
(43) Pub. Date: May 19, 2011

(54) TRANSPORTATION CART

(76) Inventor: Rogério Luiz DE SOUSA, Florianopolis (BR)

(21) Appl. No.: 12/758,091

(22) Filed: Apr. 12, 2010

(30) Foreign Application Priority Data
Nov. 18, 2009 (BR) 017090001781

(51) Int. Cl. B62B 3/00

(52) U.S. Cl. 280/47.35

(57) ABSTRACT

A transportation cart having three movable platforms for the transportation of products and/or boxes, enabling the consumer to replace the use of plastic bags by cardboard boxes, which can be recycled and reused thus reducing environmental harm caused by regular packaging.

### FIELD OF THE INVENTION

The invention refers to a cart with movable horizontal platforms for the transportation of products and/or goods.

### BACKGROUND OF THE INVENTION

Nowadays, carts are constituted of one high and deep basket which prevents a proper organization of products, frequently smashing them on top of each other. Obtaining a product from the bottom of a full basket might be difficult at times. Traditional carts were developed for storage of plastic bags with extended life not to mention that it takes several years in order for them to decompose.

The transportation cart of the present invention was developed in order to allow usage of cardboard boxes for the transportation of goods and/or products.

### SUMMARY OF THE INVENTION

The present invention seeks to provide a transportation cart comprising of: (a) a first double L-shaped frame having a long and a short section, the short section having a rear and a frontal area, (b) four rotating casters (R) attached to the short section of the first double L-shaped frame, (c) a first and a second platform attached to the long section of the first double L-shaped frame, the first platform attached to one edge of the frame and a second platform attached to a middle section of the frame, both platforms parallel to each other in a rest position, (d) a first and a second axis connecting the first and second platforms to the first double L-shaped frame, the axis enabling the tilting of the platform within a limited angle, (e) a second double L-shaped frame having a long and a short section, a first and a second edge; the short section attached to the long section of the first double L-shaped frame and the second edge attached to the short section of the first L-shaped frame, both L-shaped frames are mounted parallel to each other and (f) a third platform connected at one end to the frontal area of the short section of the first double L-shaped frame, the platform resting on the short section of the first L-shaped and is able to be tilted upwardly at the opposite end.

### BRIEF DESCRIPTION OF THE DRAWINGS

FIG. 1 shows a side view of the transportation cart.

FIG. 2 shows a top view of the transportation cart.

FIG. 3 shows a side view in perspective of the transportation cart.

FIG. 4 shows the first, second and third platform movements.

FIG. 5 shows a top view in perspective of the transportation cart.

FIG. 6 shows a top view in perspective of the first, second and third platform movements.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The cart has three movable platforms for the transportation of products and/or boxes. This new configuration enables the consumer to replace the use of plastic bags by cardboard boxes, which can be recycled and reused thus reducing environmental harm caused by regular packaging.

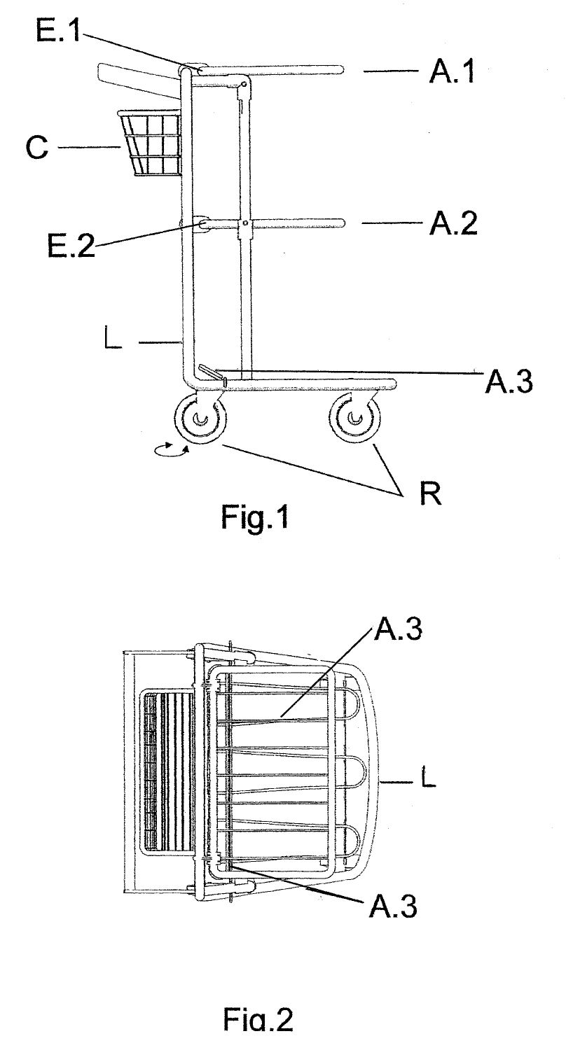

The cart comprises of four casters (R) (FIG. 1) that rotate in a vertical axis making it easier to maneuver the cart between the narrow aisles of the stores and supermarkets.

In FIG. 1 the cart is displayed as having a basket (C) for transporting a purse or other personal objects as well as three platforms: a first high platform (A.1) that can tilt upwardly at the E.1 axis, a second intermediate platform (A.2) that can tilt upwardly at the E.2 axis and a third lower platform (A.3) to facilitate the nesting of the carts as well as the disposal of larger boxes.

FIG. 2 is a top view of the cart where the shape, roundness and angles of the cart are displayed (A.3). The third platform (A.3) (FIG. 2) is the largest one of the three platforms in order to ensure the perfect balance of the entire system.

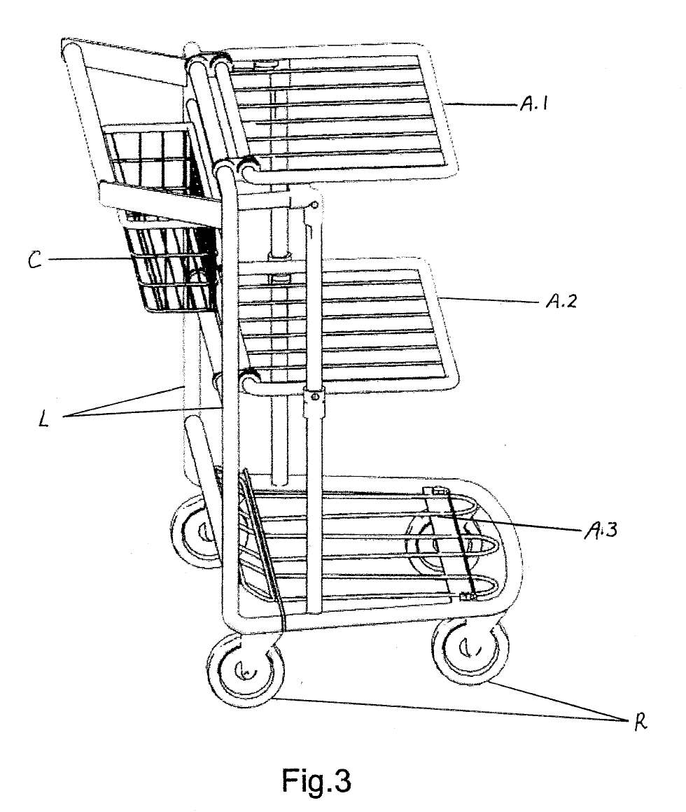

FIG. 3 is a side view in perspective of the cart, displaying all three platforms of the cart (A.1; A.2; A.3), the basket (C), the four casters (R) facilitating the movement of the cart and the double L-shaped frame (L).

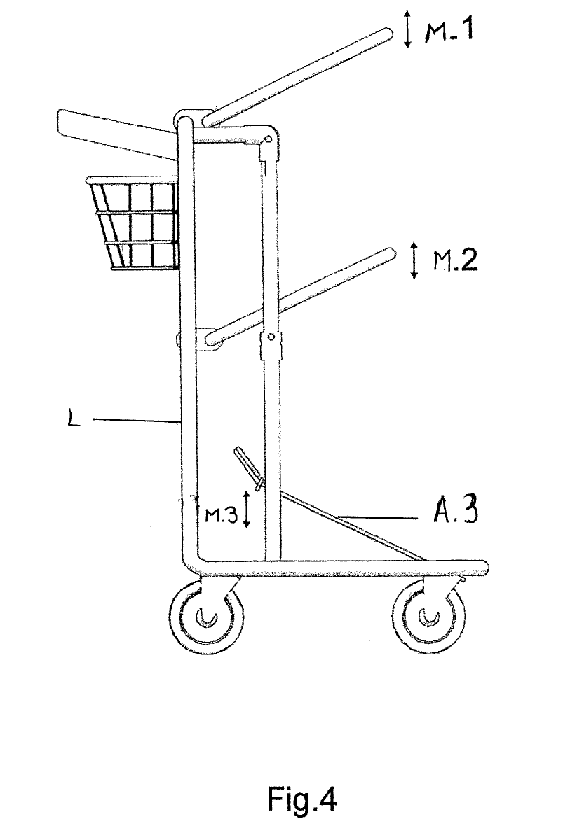

FIG. 4 is a side view of the cart identifying the upward movements (M.1 and M.2) of the first and second platforms attached to the double L-shaped frame (L). The vertical movement of the third platform is represented by M.3.

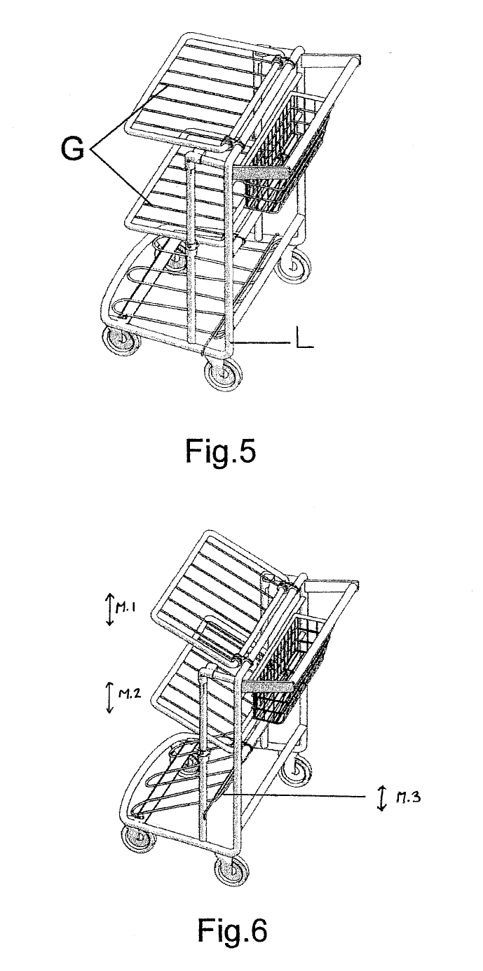

FIG. 5 shows the multiple parallel rods (G) on the first and second platform. Their configuration provides the necessary space to safely fit the neck of a twenty (20) liter water bottle.

FIG. 6 shows the upward movements of the platforms (M.1, M.2 and M.3) as displayed in FIG. 4.

Although not shown in the figures, the cart of the present invention can also be equipped with the new Radio Frequency Identification System (“RFID”). The RFID is a technology using electromagnetic waves to access data stored in a microchip placed on the goods, objects and/or products. This system reads the products' data without having to pass the product over a bar code reader. When the cart passes through the cash, the adhesive chip goes through the cashier's radio frequency field allowing the system to automatically calculate the total amount of the purchase.

1. A transportation cart comprising of:
(a) a first double L-shaped frame having a long and a short section, the short section having a rear and a frontal area;
(b) four rotating casters (R) attached to the short section of the first double L-shaped frame;
(c) a first and a second platform attached to the long section of the first double L-shaped frame, the first platform attached to one edge of the frame and a second platform attached to a middle section of the frame, both platforms parallel to each other in a rest position;
(d) a first and a second axis connecting the first and second platforms to the first double L-shaped frame, the axis enabling the tilting of the platform within a limited angle;
(e) a second double L-shaped frame having a long and a short section, a first and a second edge; the short section attached to the long section of the first double L-shaped frame and the second edge attached to the short section of the first L-shaped frame, both L-shaped frames are mounted parallel to each other;
(f) a third platform connected at one end to the frontal area of the short section of the first double L-shaped frame, the platform resting on the short section of the first L-shaped and is able to be tilted upwardly at the opposite end.

2. The transportation cart, according to claim 1, wherein the first (A.1) (FIG. 1) and second (A.2) platforms are easily tilted upwardly around two different axises (E.1; E.2) enabling the removal or the display of objects and/or products from the platforms.

3. The transportation cart, according to claim 1, wherein the platforms (G) (FIG. 5) comprise multiple parallel rods.

4. The transportation cart, according to claim 3, wherein the platforms are suitable for carrying a twenty (20) liter water bottle.
